(19) United States
(12) Patent Application Publication
(10) Pub. No.: US 2018/0087765 A1
(43) Pub. Date: Mar. 29, 2018

(54) FLEXIBLE SURFACE AREA LIGHT, IN PARTICULAR FOR USE IN A PIECE OF CLOTHING

(71) Applicant: Deutsche Institute für Textil-und Faserforschung Denkendorf, Denkendorf (DE)

(72) Inventors: Hansjürgen Horter, Oberboihingen (DE); Stefan Loy, Denkendorf (DE); Sebastian Stoll, Stuttgart (DE); Paul Hofmann, Illertissen (DE)

(21) Appl. No.: 15/552,433

(22) PCT Filed: Feb. 16, 2016
(86) PCT No.: PCT/EP2016/053250

§ 371 Date: Dec. 4, 2017

(30) Foreign Application Priority Data
Feb. 20, 2015 (DE) 10 2015 102 407.1

(51) Int. Cl. F21V 33/00; F21V 5/00; F21V 7/00

(52) U.S. Cl. CPC F21V 33/0008; F21Y 2105/10; F21V 7/0016; F21V 5/007

(57) ABSTRACT

The invention relates to a surface area light (10), in particular for use in a piece of clothing (30). The surface area light (10) according to the invention has a cover layer (11) having a light emission area (12). A reflection layer (13) having a reflection area (14) is arranged on the side opposite the cover layer (11). A first scattering layer (15) made of a textile material, preferably a textile fabric, directly adjoins the cover layer (11). The textile fabric can be connected to the cover layer in a laminar manner or can be in contact thereto. Light sources (16) are arranged at a distance from each other in a longitudinal direction L in one or more rows. The light sources (16) have a light emission side (17) which faces the reflection layer (13). A spacer means (19) secures a minimum distance between the light sources (16) and the reflection layer (13). The light emitted from the light sources (16) is reflected on the reflection layer (13) to the cover layer (11). The optical path within the surface area light (10) can thus be enlarged without enlarging the thickness of the surface area light (10) at a right angle to the light emission area (12).

The invention relates to a flexible panel light, which is particularly adapted for use in an article of clothing. Furthermore, the invention relates to an article of clothing with such a panel light, for example, a jacket. The panel light can also be attachable to an article of clothing, such as a jacket, as an attachable and removable element, for example, a back label, breast label or arm label. Fasteners such as buttons, Velcro fasteners, etc. can be used for detachable connection. The panel light, when used in an article of clothing, can serve to increase the visibility of the person wearing the article of clothing and/or to display information to other persons, such as an identification of an operational force, for example, rescue personnel, security personnel, or support personnel.

U.S. Pat. No. 8,690,385 B2 describes a light-emitting electronic textile, Light-emitting diodes are arranged on a flexible substrate and inserted into a textile tube. This textile tube can be attached to a garment. However, it has been found that the diffusion effect in such embodiments is frequently insufficient and therefore there is no two-dimensional visual effect from the light emission. Some embodiments of U.S. Pat. No. 8,690,385 B2 provide for several textile layers to be arranged between the light-emitting diodes and the emission side of the surrounding textile tube, wherein the individual layers are spaced by air layers This results in a respective refractive index at the boundary layer between a textile layer and an adjacent air layer. However, it is disadvantageous in this embodiment that a large thickness is required. In addition, the refractive effect is greatly changed when the person wearing the article of clothing is in motion and, for example, air gaps are not maintained and thus boundary layers are at least partially eliminated.

DE 10 2013 021 600 A1 describes a panel light for illuminating two-dimensional elements such as surfaces of body trim in the interior of vehicles. The panel light is multi-layer formed, A carrier structure with a carrier layer adjoins a light-emitting surface. A protective layer is provided on the side of the carrier structure opposite the carrier layer. Within the protective layer, a decoupling structure is arranged, by means of which light can be emitted into the carrier layer or the carrier structure and can emerge at the light-emitting surface. The rear side of the light-emitting surface can be covered by a reflective cover layer. The carrier structure preferably consists of a polymer plastic. The decoupling structure can be produced by a screen printing process, by embossing, rolling, lasing, grinding or the like.

Starting on this prior art, it can be considered as objective of the present invention to provide a flexible panel light, which is particularly suitable for use in articles of clothing.

This objective is achieved by the flexible panel light with the features of patent claim 1.

The flexible panel light has a cover layer, at which the light-emitting surface is present. Preferably, one side of the cover layer serves as the light-emitting surface. A reflective layer is present on the side of the panel light, which is opposite the cover layer. Total reflection of the incoming light occurs at the reflection layer. A first diffusion layer made of a textile material adjoins the cover layer. The first diffusion layer is preferably in direct planar contact with the cover layer. In the area between the reflection layer and the cover layer, and preferably between the first diffusion layer and the reflection layer, multiple illuminants, preferably semiconductor illuminants, are arranged. The illuminants emit the light particularly in a point-shaped or hemispherical manner in the direction. of the reflection layer. Thus, the emission direction of the illuminants is directed away from the light-emitting surface. A spacer means is provided, which is arranged between the illuminants and the reflection layer and ensures that there is a minimum distance between the illuminants and the reflection layer. The spacer means is supported for example at the reflection layer on one side and at one or more respective illuminants on the other side and can also be connected with the reflective layer and/or the one or more illuminants.

The cover layer, the reflective layer, and the first diffusion layer are made of a flexible material. A flexible material here is to be understood as an elastically bendable material, which elastically deforms due to deforming forces that usually occur during wear of the articles of clothing when the person wearing the articles of clothing moves.

Because the illuminants do not emit the light directly onto the light-emitting surface, but instead initially emit the light in the opposite direction onto the reflection layer, the path, which the light travels within the flexible panel light is increased without the overall thickness of the panel light increasing. In this way, an improved uniform light emission or an improved diffusion effect can be achieved respectively with a low total thickness of the panel light. The thickness of the panel light is essentially determined by the distance of the reflection layer from the light-emitting surface. Due to a minimal thickness and a low weight, the mobility or flexibility of the panel light is improved and the wearing comfort is increased when using the panel light integrated into an article of clothing. By increasing the light path within the panel light, undesired large brightness differences of the light emitted at the light-emitting surface can be avoided.

The spacer means can have at least one casting body or lens body or can be formed by at least one casting body or lens body. The at least one casting body covers the illuminant on its light-emitting side. A casting body or lens body can also cover a group of several sources respectively. However, preferably not all of the illuminants are connected by a single casting body or lens body since the flexibility of the panel light can thereby be restricted and the overall weight increases.

The casting body or lens body can consist of a rigid or an elastically flexible material. In this case, a material is considered to be elastically flexible that can deform elastically in the case of forces acting on the panel light when used correctly (e.g. in or on an article of clothing). If this is not the case, the material is regarded as “rigid”.

If, in one embodiment, a group of several illuminants is rigidly connected by means of a casting body or lens body and/or a rigid carrier or the like, the number of the illuminants of a group is preferably at most 5 and further preferably at most 3.

When a casting body or lens body is present, a separate casting or lens body is assigned to each illuminant preferably.

It is also advantageous if an area-measured textile fabric is contained in a casting body or lens body as diffusion material. As an alternative to this, an area-measured textile fabric can also be materially bonded to the Illuminants in a different way, for example with an adhesive bond. As a result, a definite orientation and position of the textile fabric can be predetermined and maintained with respect to the illuminant.

In one embodiment, the spacer means can have a transparent layer and/or a second diffusion layer, which preferably is in planar and direct abutment against the reflection layer. The respective layer is arranged in this case between the illuminants and the reflection layer. The spacer means can also be formed by such a layer. The transparent layer and/or the second diffusion layer is designed to be flexible analogously to the other layers of the panel light. The illuminants can be arranged between the first diffusion layer and the transparent layer or the second diffusion layer respectively, and can be held there by an elastic deformation force of at least one of the two adjacent layers.

In a preferred embodiment, the second diffusion layer consists of a textile material. Preferably, the first diffusion layer and/or the second diffusion layer are formed by at least one area-measured textile fabric. A fleece material and/or woven fabric and/or knitted fabric can be used as a textile fabric. Such textile fabrics can be manufactured simply and inexpensively. The diffusing effect can be very easily influenced by the material used and/or the density of the fibers or yarn and/or by the orientation of the fibers or yarn and/or by the type of weaving construction and/or by the cross-sectional shape of the yarn or the fiber and/or by the density of the textile material. The density of the textile material can, for example, be determined in the case of a woven. fabric or a knitted fabric by the distance between directly adjacent yarn or filaments (mesh width or warp and weft thread density), and in the case of a fleece material by the average distance between the fibers. The diffusion will be at least partly determined by the porosity of the textile material, so to speak.

When a woven fabric and/or a knitted fabric and/or a warp knitted fabric is used as a first diffusion layer and/or a second diffusion layer, a three-dimensional woven fabric or a knitted fabric or warp knitted fabric can be used in one embodiment. For example, a three-dimensional textile having multiple layers and pile yarn or connecting yarn arranged in between. By means of the length of the pile yarn, the desired thickness of the diffusion layer can be adjusted very simply.

If the respective diffusion layer comprises knitted fabric or is formed by knitted fabric, a weft knitted fabric and/or warp knitted fabric—or as mentioned a three-dimensional weft knitted fabric or warp knitted fabric—can also be used.

It is also possible to arrange a combination of the above-mentioned textile fabrics in several layers in the first diffusion layer and/or in the second diffusion layer. In any layer, the fiber orientation may be the same or different from the other layers and/or the meshes or yarns or fibers of different layers may be offset parallel to the plane in which the light-emitting surface extends, in order to improve the diffusion effect.

Preferably, the illuminants are not rigidly connected to one another. The illuminations can be connected in series and/or parallel to one another via flexible conductors. The illuminants can also be arranged on a common flexible carrier, As a carrier, for example, a textile strip made of a textile fabric can be used.

The flexible panel light can be part of an article of clothing. The light-emitting surface is thereby at least partially visible from the outside. The flexible panel light can be connected to one or more layers of the article of clothing for example by adhesive bonding and/or sewing . The panel light can also be detachably connected to the garment, for example by means of buttons, in particular snaps, or by Velcro fasteners.

The textile material can also be designed to create a specific non-uniform light emission or diffusion. For example, the textile material piece can be colored or differently colored in sections in order to at least partially absorb particular light wavelength ranges in sonic cases or to completely shield the light radiation in at least one area. It is additionally or alternatively possible to make the textile material piece in sections with different fiber or yarn orientations and/or weaving construction and/or fiber or yarn cross-sections.

In an embodiment of the panel light, the cover layer or other existing layers can also be at least partially colored or differently colored in sections and/or partially provided with a surface structure or with different surface structures in sections.

Advantageous embodiments of the invention are obvious from the dependent claims, the description below, and the drawings. In the following, preferred embodiments are explained in detail with reference to the accompanying drawings. The drawings show:

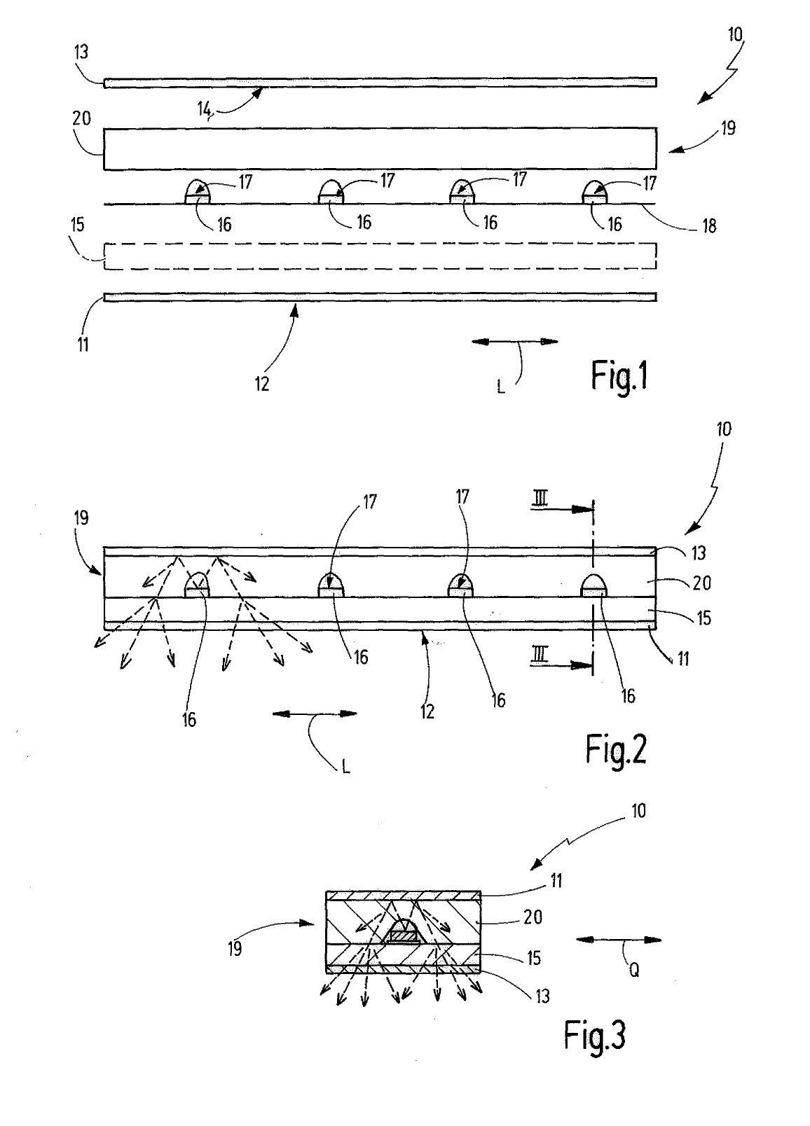

FIG. 1 a schematic illustration of a first embodiment of a flexible panel light in a side view;

FIG. 2 the exemplary embodiment of the panel light according to FIG. 1 in a schematic, block diagram illustration in side view;

FIG. 3 a cross-section through the embodiment of the panel light according to FIGS. 1 and 2 along the sectional line III-III in FIG. 2;

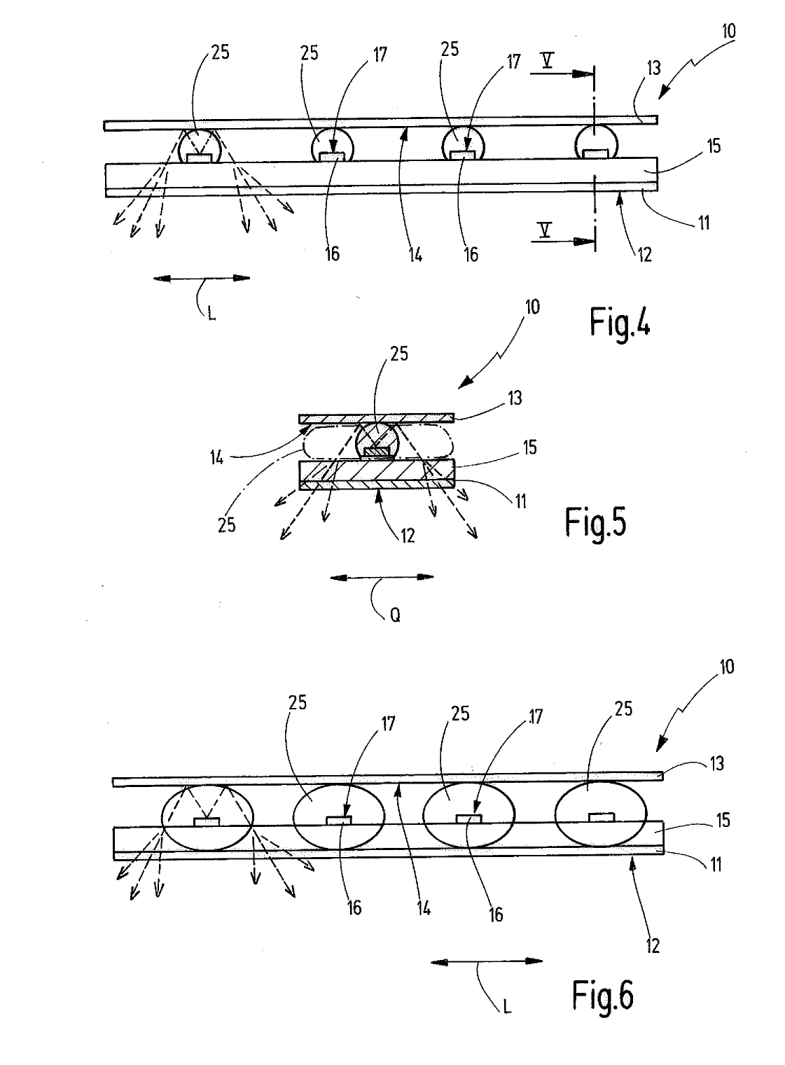

FIG. 4 a further embodiment of a flexible panel light in a schematic block-diagram side view;

FIG. 5 the embodiment of the panel light of FIG. 4 in a cross-section according to the sectional line V-V in FIG. 4;

FIG. 6 a further embodiment of a panel light in a schematic block-diagram side view;

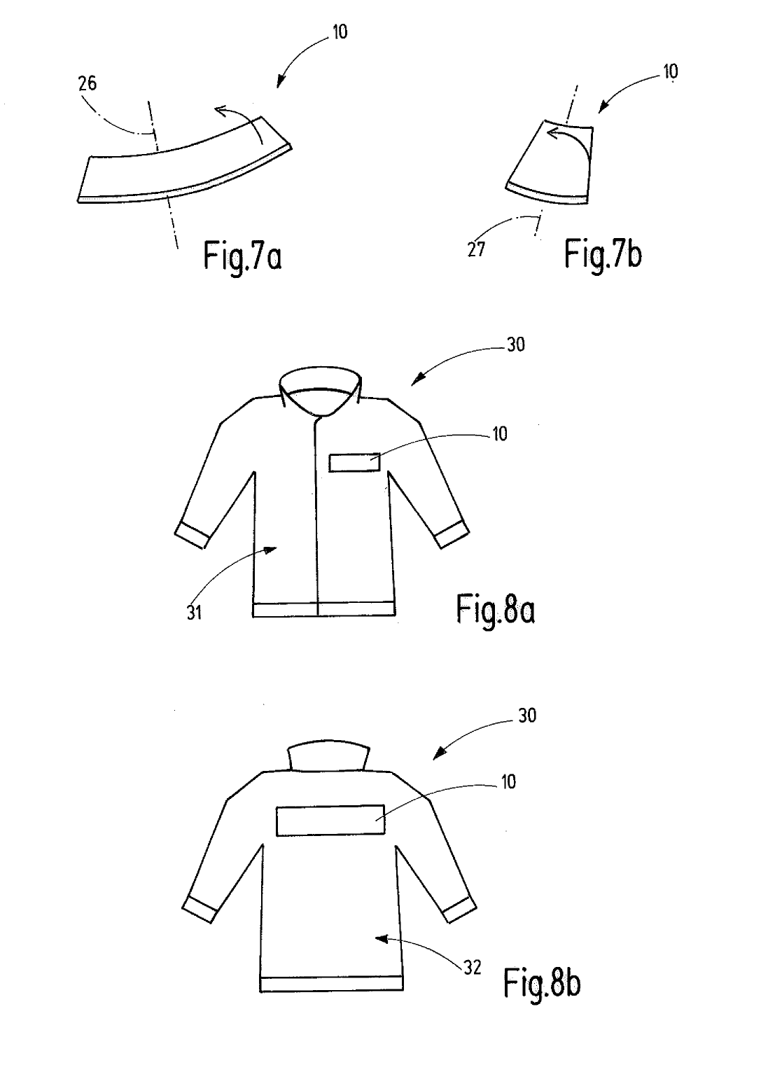

FIGS. 7a and 7b a schematic, perspective illustration of the bendability of the embodiments of the flexible panel lights according to FIGS. 1 to 6 respectively and

FIGS. 8a and 8b a schematic illustration of an article of clothing in the form of a jacket with an integrated panel light respectively.

FIG. 1 to 3 illustrate a first embodiment of a flexible panel light 10. Flexible panel light 10 has a transparent cover layer 11. A light-emitting surface 12, on which the light from panel light 10 emerges, is present on transparent cover layer 11. Cover layer 11 is transparent at least for the light wavelength or the light wavelength spectrum, which is to be emitted by panel light 10, for example, for white light or also light of a specific color.

On its side opposite cover layer 11, panel light 10 has a reflection layer 13 with a reflection surface 14, Reflection surface 14 faces cover layer 11. No light can escape through reflection layer 13. The light incident on the reflecting surface 14 is totally reflected.

On the side of cover layer 11, which is opposite the light-emitting surface 12, a first diffusion layer 15, which consists of a textile material, optionally adjoins. First diffusion layer 15 is formed by a textile fabric or comprises at least one textile fabric. A textile fabric can be formed from a fleece material, a woven fabric a weft knitted fabric or a warp knitted fabric. By means of the fibers or threads of the textile fabric of the first diffusion layer, the light is refracted and/or reflected and/or diffrected, as a result of which a diffusion and a generally good two-dimensional light emission with small differences in brightness within light-emitting surface 12 can be achieved. In the first embodiment, the diffusion effect is illustrated schematically by way of example in FIGS. 2 and 3.

Multiple illuminants 16 are arranged between the cover layer 11 and the reflection layer 13 and, for example, between the first diffusion layer 15 and the reflection layer 13. Each illuminant 16 has a light emitting side 17, which faces reflection surface 14. The light emerging at light emitting side 17 of the illuminants 16 is therefore emitted toward the reflection surface 14 and is reflected there toward the cover layer 11 or light-emitting surface 12 respectively.

A transverse direction and a longitudinal direction L span a plane, which is aligned parallel to light-emitting surface 12 and/or to the reflection surface 14 and/or is oriented at a right angle to the optical axes of illuminants 16.

Illuminants 16 are preferably embodied by semiconductor illuminants, in particular light-emitting diodes or light-emitting diode chips. Illuminants 16 can be arranged on a common flexible carrier 18, for example, a textile strip. Illuminants 16 are electrically connected in series and/or parallel to one another and/or individually to a current or voltage source, respectively. For this purpose, they are connected to flexible electrical conductors, which can be integrated into carrier 18. Carrier 18 is optional and can also be omitted.

The illuminants 16 can form separately controllable groups. The illuminants 16 of each controllable group can then be arranged spatially at the intended locations in the panel light, for example in order to form characters, symbols, letters, in each case a segment of a 7-segment display, etc.

A spacer means 19 is present between the illuminants 16 and reflection layer 13. The spacer means 19 ensures that a minimum distance is maintained between light emitting side 17 of the illuminants 16 and the reflecting surface 14 even if the panel light is elastically deformed.

In the first design embodiment according to FIGS. 1 to 3, the spacer means 19 is formed by a further layer, which extends between the illuminants up to the reflection layer 13 and, for example, is embodied as a second diffusion layer 20. If the second diffusion layer 20 is present, first diffusion layer 15 can also be omitted. It is generally sufficient fur the panel light, if at least one diffusion layer 15 or 20 is present.

Second diffusion layer 20 consists for example of textile material, analogous to first diffusion layer 15, and in the case of a preferred embodiment, is formed by a textile fabric or contains at least one such a textile fabric. The diffusion effect can be further improved by means of this second diffusion layer 20. Illuminants 16 are arranged in the area between two diffusion layers 19, 20 and can be held due to at least one of the two diffusion layers 19, 20 deforms elastically and illuminants 16 are thereby held by force-fit.

Instead of the second diffusion layer 20, a transparent, non-diffusing layer or another suitable spacer means 19 could also be used.

The light path from light-emitting side 17 of illuminants 16 to light-emitting surface 12 is increased by the fact that the light from illuminants 16 is not emitted directly to light-emitting surface 12 but instead oppositely to the reflecting surface 14. The light initially passes through the distance defined by spacer means 19 to reflection surface 14, is totally reflected there, passes through the distance specified by spacer means 19 again, then passes through the first diffusion layer 15, passes through the cover layer 11 and exits at the light-emitting surface 12 of the cover layer 11. When the spacer means 19 is also formed by a diffusion layer (second diffusion layer 20), the light passes along the whole distance up to cover layer 13 through a diffusing layer, namely the first diffusion layer 15 and the second diffusion layer 20. The diffusion and, consequently, the uniform light emission with minimal differences in brightness within light-emitting surface 12 is further optimized in this way. For the eye of an observer, a very uniform luminous effect is produced at light-emitting surface 12 of panel light 10.

FIGS. 4 and 5 show a modified design embodiment of panel light 10. In this case, spacer means 19 is not formed by a layer but by multiple casting bodies 25. Instead of casting bodies 25, lens bodies could also be used. In the preferred embodiment, a separate casting body 25 is assigned to each illuminant 16. In modification thereto it would also be possible to cover or integrate a group of several, for example two to ten illuminants 16 or all illuminants 16, by means of a common casting body 25.

The reflection surface 14 of the reflection layer 13 abuts against the casting bodies 25, The reflection layer 13 is so to speak supported on the casting bodies 25. In order to achieve sufficient support, the illuminants 16 with casting bodies 25 can also be arranged in multiple rows, which are spaced apart in the transverse direction Q and extend in the longitudinal direction L, or otherwise arranged in a plane spanned by the longitudinal direction L and transverse direction Q. In the illustrated embodiments, the illuminants 16 are arranged in longitudinal direction L only in one row with a distance from one another. In all embodiments, several such rows could also be arranged on a common carrier 18 or on different carriers 18.

In order to achieve sufficient support in the embodiment according to FIGS. 4 and 5 with a single row of illuminants 16, the casting body 25 can have a larger dimension in a transverse direction Q oriented at right angle to longitudinal direction L than in the longitudinal direction L, which is illustrated schematically by dotted lines in FIG. 5. The shape of casting body 25 can vary thereby.

It is also possible to embody the spacer means 19 by a combination of a layer, in particular a second diffusion layer 20, and of multiple casting bodies 25. Thereby in a modification of the embodiment of FIGS. 4 and 5, a distance can also be present between reflection layer 14 and casting body 25.

FIG. 6 shows a further modified embodiment of panel light 10. This embodiment corresponds essentially to the embodiment illustrated in FIG. 4 and 5, wherein the casting bodies 25 in the embodiment according to FIG. 6 also extend into first diffusion layer 15 and define, according to the example, the distance between the reflection layer 13 and the cover layer 11.

In FIGS. 7a and 7b, the flexibility or bendability of panel light 10 is schematically illustrated, The panel light 10 can be bent or elastically deformed around one or more first axes 26 aligned parallel to transverse direction Q and/or one or more second axes 27 aligned parallel to the longitudinal direction L.

FIGS. 8a and 8b schematically illustrate an article of clothing 30 in the form of a jacket, in which FIG. 8a shows front side 31, and FIG. 8b shows rear side 32 of the jacket. A panel light 10 according to the invention can be present on the front side 31 and/or on the rear side 32. Particularly in the case of articles of clothing for action forces, such as police officers, firefighters, rescue forces, etc., recognizability can be increased by the panel light 10 regardless of the light conditions and the external circumstances. In addition, information (symbols, letters, numbers, etc.) can be displayed by a corresponding imprinting or formation of the light-emitting surface 12. The action threes can thus be identified what is for example common in large firefighting or police operations.

A voltage or current supply for illuminants 16 can be integrated into a pocket of clothing article 30. If light sources 16 are formed by semiconductor illuminants, in particular light-emitting diodes, one or more series resistors may be required for operating the illuminants in order to be able to operate illuminants 16 with a voltage source, such as an accumulator or a battery. The at least one series resistor can be arranged directly to the respective illuminant 16 and/or on carrier 18. In this case, it is also possible to use a series resistor for several illuminants 16.

In all design embodiments, the first diffusion layer 15 and/or second diffusion layer 16 can be formed as an area-measured textile fabric or comprise such. For example, a woven fabric and/or weft knitted fabric and/or warp knitted fabric and/or a fleece fabric can be used as textile fabric material. The woven fabric can be realized, for example, as a three-dimensional woven fabric with several woven fabric layers, the fabric layers being connected with each other by means of pile yarns. Each diffusion layer 15, 20 can also have multiple textile fabrics, for example also fabrics of different types, such as a woven fabric in combination with a knitted fabric.

The reflective layer 13 as well as the first diffusion layer 15 and, if present, the second diffusion layer 19, as well as cover layer 11, are flexible and can be bent in the case of the forces, which usually occur during the wearing of an article of clothing 30. As a result, an adaptation of clothing 30 to the body shape or body posture is also ensured where the panel light 10 is integrated into the article of clothing 30. In this way, the movement of the person wearing the article of clothing 30 is not or only slightly affected.

The invention relates to a panel light 10, in particular for use in an article of clothing 30. The panel light 10 has a cover layer 11 with a light-emitting surface 12. A reflection layer 13 with a reflection surface 14 is arranged on the side opposite cover layer 11. A first diffusion layer 15 of a textile material, preferably a textile fabric, directly adjoins the cover layer 11. The textile fabric can be in planar connection to the cover layer or in planar abutment against it. In a longitudinal direction L, the illuminants 16 are arranged at a distance from one another in one or more rows. The illuminants 16 have a light-emitting side 17, which faces reflection layer 13. A spacer means 19 ensures a minimum distance between the illuminants 16 and the reflection layer 13. The light emitted by the illuminants 16 is reflected on reflection layer 13 towards cover layer 11. As a result, the light path within the panel light 10 can be increased without increasing the thickness of panel light 10 at a right angle to light-emitting surface 12.

### REFERENCE LIST

10 Panel light
11 Cover layer
12 Light-emitting surface
13 Reflection layer
14 Reflection surface
15 first diffusion layer

### 16 Illuminant

17 Light-emitting side

### 18 Carrier

19 Spacer means
20 second diffusion layer
25 Casting body
26 first axis
27 second axis
30 Article of clothing
31 Front side
32 Back side
L Longitudinal direction
Q Transverse direction

1-15. (canceled)

16. A flexible panel light for use in an article of clothing, comprising:
a light-emitting surface which is present on a cover layer;
a reflection layer which is arranged on the side opposite the cover layer;
at least one diffusion layer of a textile material arranged between the cover layer and the reflection layer;
a plurality of light sources that are arranged between the reflection layer and the cover layer and that radiate light away from the cover layer toward the reflection layer; and
a spacer element that is arranged between the light sources and the reflection layer and that ensures a predetermined spacing between the light sources and the reflective layer.

17. A flexible panel light according to claim 16, wherein the light sources are embodied as point-like or hemispherically emitting light sources.

18. A flexible panel light according to claim 16, wherein the plurality of light sources are formed by semiconductor light sources.

19. A flexible panel light according to claim 16, wherein the spacer element comprises at least one casting element covering a light emitting side of one or more light sources.

20. A flexible panel light according to claim 19, wherein each light source includes a casting element.

21. A flexible panel light according to claim 19, wherein an area-measured textile fabric material is contained as a diffusion material in the casting element.

22. A flexible panel light according to claim 16, wherein the at least one diffusion layer comprises a first diffusion layer which adjoins the cover layer.

23. A flexible panel light according to claim 16, wherein the spacer element comprises a second diffusion layer between the light sources and the reflection layer.

24. A flexible panel light according to claim 23, wherein at least one of the first diffusion layer and the second diffusion layer consists of a textile material.

25. A flexible panel light according to claim 23, wherein at least one of the first diffusion layer and the second diffusion layer has at least one area-measured textile fabric.

26. A flexible panel light according to claim 24, wherein the textile material of the at least one of the first diffusion layer and second diffusion layer consists of at least one of a fleece material, a woven fabric and a knitted fabric.

27. A flexible panel light according to claim 26, wherein the textile material is embodied as a three-dimensional textile fabric.

28. A flexible panel light according to claim 24, wherein the textile material is a warp knitted fabric or weft knitted fabric.

29. A flexible panel light according to claim 16, wherein the plurality of light sources are not rigidly connected to one another.

30. An article of clothing comprising:
a flexible panel light comprising:
a light-emitting surface which is present on a cover layer;
a reflection layer which is arranged on the side opposite the cover layer;
at least one diffusion layer of a textile material arranged between the cover layer and the reflection layer;
a plurality of light sources that are arranged between the reflection layer and the cover layer and that radiate the light away from the cover layer toward the reflection layer; and
a spacer element that is arranged between the light sources and the reflection layer and that ensures a predetermined spacing between the light sources and the reflective layer.
